(19) United States
(12) Patent Application Publication
(10) Pub. No.: US 2011/0094267 A1
(43) Pub. Date: Apr. 28, 2011

(54) METHODS OF PRODUCING GLASS SHEETS

(76) Inventors: Kenneth William Aniolek, Painted Post, NY (US); Rui Zhang, Elmira, NY (US)

(21) Appl. No.: 12/607,474

(22) Filed: Oct. 28, 2009

(51) Int. Cl. C03B 17/06

(52) U.S. Cl. 65/91

(57) ABSTRACT

A method of producing glass sheets includes the step of fusion drawing a glass ribbon along a draw direction into a viscous zone downstream from a root of a forming wedge. The method further includes the step of drawing the glass ribbon into a setting zone downstream from the viscous zone, wherein the glass ribbon is set from a viscous state to an elastic state. The method further includes the steps of drawing the glass ribbon into an elastic zone downstream from the setting zone and stabilizing a region of the glass ribbon in the elastic zone along a width of the glass ribbon extending transverse with respect to the draw direction. A predetermined pressure differential between a first side and a second side of the glass ribbon is used to create the stabilized region. The method further includes the step of cutting a glass sheet from the glass ribbon, wherein the stabilized region inhibits shape instabilities from propagating upstream through the glass ribbon to the setting zone.

### TECHNICAL FIELD

The present invention relates generally to methods for producing glass sheets, and more particularly to methods of producing glass sheets by fusion drawing a glass ribbon from a root of a forming wedge.

### BACKGROUND

Methods of manufacturing glass sheets are known to include the step of fusion drawing a glass ribbon from the root of a forming wedge. Once drawn from the root, the glass ribbon is set from a viscous state to an elastic state. After reaching the elastic state, the end portion of the glass ribbon is then periodically cut to provide a glass sheet having the desired length.

### SUMMARY

The following presents a simplified summary of the disclosure in order to provide a basic understanding of some example aspects described in the detailed description.

In one example aspect, a method of producing glass sheets includes the step of fusion drawing a glass ribbon along a draw direction into a viscous zone downstream from a root of a forming wedge. The method further includes the step of drawing the glass ribbon into a setting zone downstream from the viscous zone, wherein the glass ribbon is set from a viscous state to an elastic state. The method further includes the steps of drawing the glass ribbon into an elastic zone downstream from the setting zone and stabilizing a region of the glass ribbon in the elastic zone along a width of the glass ribbon extending transverse with respect to the draw direction. A predetermined pressure differential between a first side and a second side of the glass ribbon is used to create the stabilized region. The method further includes the step of cutting a glass sheet from the glass ribbon, wherein the stabilized region inhibits shape instabilities from propagating upstream through the glass ribbon to the setting zone.

### BRIEF DESCRIPTION OF THE DRAWINGS

These and other aspects are better understood when the following detailed description is read with reference to the accompanying drawings, in which:

FIG. 1 is a schematic view of an example fusion drawing apparatus being used to fusion draw a glass ribbon;

FIG. 2 is a cross sectional view along line 2-2 of FIG. 1, schematically illustrating features of an example cutting device;

FIG. 3 is a cross sectional view along line 3-3 of FIG. 1, schematically illustrating features of an example stabilization device;

FIG. 4 is an enlarged view of portions of FIG. 3;

FIG. 5 is a flow chart representing methods of producing glass sheets;

FIG. 6 is an example cross-sectional view of the glass ribbon along lines 6A-6A, 6B-6B and 6C-6C of FIG. 1;

FIG. 7 is an example cross-sectional view of another glass ribbon along lines 6A-6A, 6B-6B and 6C-6C of FIG. 1;

FIG. 8 schematically illustrates stabilizing a region of the glass ribbon and scoring the glass ribbon;

FIG. 9 schematically illustrates applying a rotational force to the glass sheet about a score line while the glass sheet is supported behind the score line by an anvil portion; and

FIG. 10 schematically illustrates breaking away of the glass sheet along the score line and the stabilized region inhibiting shape instabilities from propagating upstream through the glass ribbon.

### DETAILED DESCRIPTION

Examples will now be described more fully hereinafter with reference to the accompanying drawings in which example embodiments are shown. Whenever possible, the same reference numerals are used throughout the drawings to refer to the same or like parts. However, aspects may be embodied in many different forms and should not be construed as limited to the embodiments set forth herein.

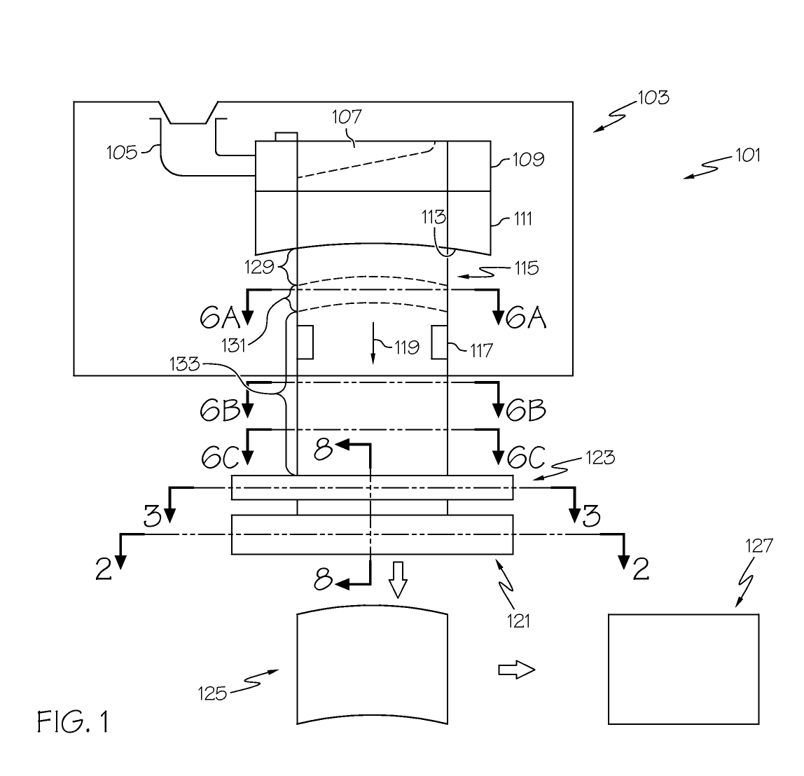

Methods herein can be incorporated with various fusion drawing apparatus designed to be used to fusion draw glass ribbon. The fusion drawing apparatus can include features disclosed in U.S. Pat. App. Pub. No. 2008/0131651 and U.S. Pat. Nos. 3,338,696 and 3,682,609 that are herein incorporated by reference in their entirety. One example fusion drawing apparatus 101 is illustrated schematically in FIG. 1. As shown, the fusion drawing apparatus 101 can include a fusion draw machine 103 configured to receive molten glass through an inlet 105 to be received in a trough 107 of a forming vessel 109. The forming vessel 109 can be provided with a forming wedge 111 configured to facilitate fusion drawing a glass ribbon 115 from a root 113 of the forming wedge 111 as discussed more fully below. A pull roll assembly 117 can facilitate pulling of the glass ribbon 115 in a draw direction 119.

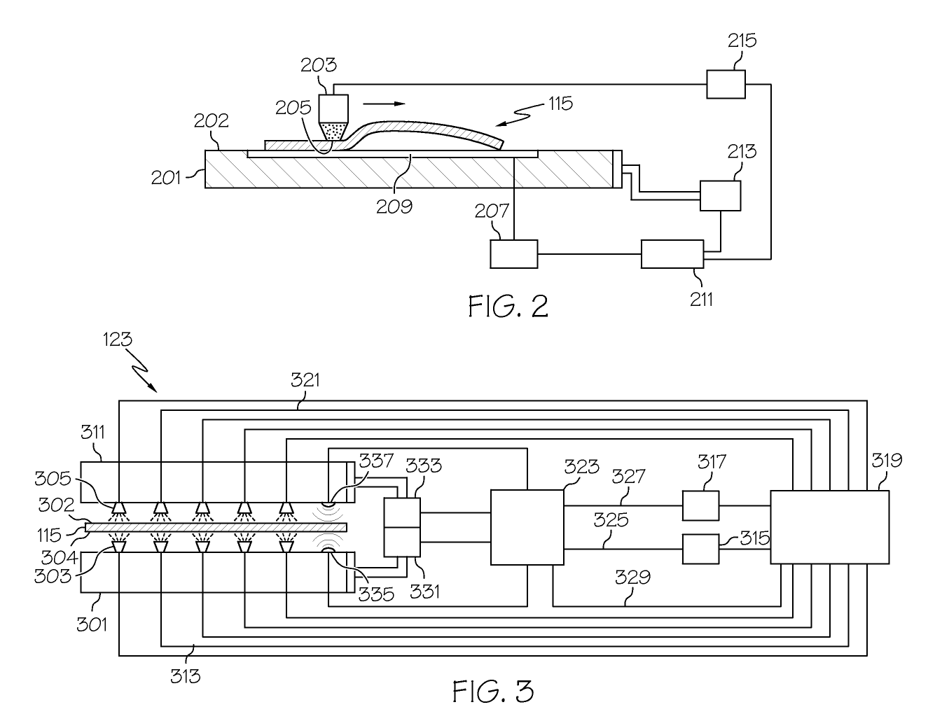

The fusion drawing apparatus 101 further includes a cutting device 121 and a stabilization device 123. A single stabilization device 123 is illustrated although a plurality of stabilization devices may be provided in further examples. For instance, two or more stabilization devices may be provided. The cutting device 121 allows the glass ribbon 115 to be cut into distinct glass sheets 125. The glass sheets 125 may be subdivided into individual display glass sheets 127 for incorporating in the various display devices, such as a liquid crystal display (LCD). Cutting devices may include laser devices, mechanical scoring devices and/or other devices configured to cut the glass ribbon 115 into the distinct glass sheets 125. As shown in FIG. 2, one example cutting device 121 can include a traveling anvil machine. The traveling anvil machine may include an anvil portion 201 with a wedge ending in an apex 202. The apex 202 is designed to support the glass ribbon during a scoring and breaking procedure. The traveling anvil machine also includes a scoring portion 203 with a working end 205 designed to score a break line in the glass ribbon 115. In one example, the working end 205 can comprise a diamond point scriber or diamond wheel scriber although other scoring structures may be used in further examples.

The cutting device 121 may optionally include a fluid vacuum nozzle and/or a fluid emitting nozzle to help stabilize the glass ribbon and/or to help remove glass chips from the vicinity of the glass ribbon when cutting the glass sheets 125 from the glass ribbon 115. For instance, as shown in FIG. 2, the traveling anvil machine may be provided with a vacuum device 207 in fluid communication with a vacuum channel 209. A computer controller 211 may be provided to control operation of the vacuum device 207. The computer controller 211 can also be placed in operable communication with an anvil actuator 213 and/or a score actuator 215. Based on commands from the computer controller 211, the anvil actuator 213 can position the anvil portion 201 at an appropriate location to support the glass ribbon 115 during scoring and subsequent breaking of the glass sheet 125. Likewise, the score actuator 215 can control movement of the scoring portion 203 based on commands from the computer controller 211.

The fusion drawing apparatus 101 further includes a stabilization device 123 configured to stabilize a region of the glass ribbon by application of a pressure differential. As shown, the pressure differential can be achieved by direct contact with the glass ribbon by way of a fluid material (e.g., gas, liquid or vapor). The fluid material may optionally be heated or cooled depending on the particular application. For instance, the fluid material may be heated to correspond to the temperature of the glass ribbon within the stabilized region to avoid potential stress cracking of the glass ribbon. In further examples, the pressure differential can be achieved by way of a solid object (e.g., pressure bar, pressure pins, or the like). As shown in FIG. 3, the stabilization device 123 can include a first pressure member 301 positioned adjacent a second side 304 of the glass ribbon 115. Likewise, the stabilization device 123 can further include a second pressure member 311 positioned adjacent a first side 302 of the glass ribbon 115. While two pressure members are illustrated, further examples can include a single pressure member adjacent one side of the glass ribbon. In still further examples, two or more pressure members may be provided on one or both sides of the glass ribbon.

The one or more pressure members may be designed to induce a positive or negative pressure influence to the corresponding portion of the glass ribbon. For instance, one or both of the pressure members may be provided with a single elongated fluid nozzle extending along the width of the corresponding pressure member. Providing a single elongated fluid nozzle may be desirable to simplify the stabilization device and to provide an even pressure distribution along the width of the corresponding pressure member. Alternatively, one or both of the pressure members may be provided with a plurality of fluid nozzles extending along the width of the corresponding pressure member. If provided, the plurality of fluid nozzles can be evenly spaced or spaced in an uneven manner along the width of the corresponding pressure member. The desired pressure profile along the width of the pressure member can be controlled, in part, by the spacing between the fluid nozzles. Regardless of the number or spacing of the fluid nozzles, fluid characteristics from one or a set of nozzles may be controlled to provide the desired pressure differential characteristics.

As shown schematically in FIG. 3, the first pressure member 301 may include a plurality of fluid nozzles 303. As shown, each fluid nozzle 303 is evenly spaced along the width of the first pressure member 301 although other uneven spacing arrangements may be provided in further examples. Likewise, the illustrated second pressure member 311 can include a plurality of fluid nozzles 305. As shown, each fluid nozzle 305 is also evenly spaced along the width of the second pressure member 311 although uneven spacing arrangements may be provided in further examples. Each fluid nozzle may include a corresponding fluid conduit placed in communication with at least one of a positive pressure source 315 and a negative pressure source 317 by way of a fluid control manifold 319. For instance, each fluid nozzle 303 of the first pressure member 301 may include a fluid conduit 313 operably connected between the manifold 319 and the corresponding fluid nozzle 303 of the first pressure member 301. Likewise, each fluid nozzle 305 of the second pressure member 311 may include a fluid conduit 321 operably connected between the manifold 319 and the corresponding fluid nozzle 305 of the second pressure member 311.

A computer controller 323 may transmit commands along a transmission line 325 to control the positive pressure source 315. For example, the positive pressure source 315 may be a pressure pump wherein the computer controller 323 can send commands along a transmission line 325 to control operation of the pressure pump. Likewise, the computer controller 323 may transmit commands along another transmission line 327 to control the negative pressure source 317. For example, the negative pressure source 317 may comprise a vacuum pump wherein the computer controller 323 can send commands along the transmission line 327 to control operation of the vacuum pump 317. Still further, the computer controller 323 may also send signals along transmission line 329 to control operation of the manifold 319 depending on the desired pressure profile. In one example, the manifold 319 can cause at least one or all of the fluid nozzles 303 of the first pressure member 301 and/or at least one or all of the fluid nozzles 305 of the second pressure member 311 to be placed in fluid communication with the positive pressure source 315 and/or the negative pressure source 317. Therefore, it is possible for each nozzle 303, 305 to selectively act as either a fluid emitting nozzle or a fluid vacuum nozzle depending on the particular application.

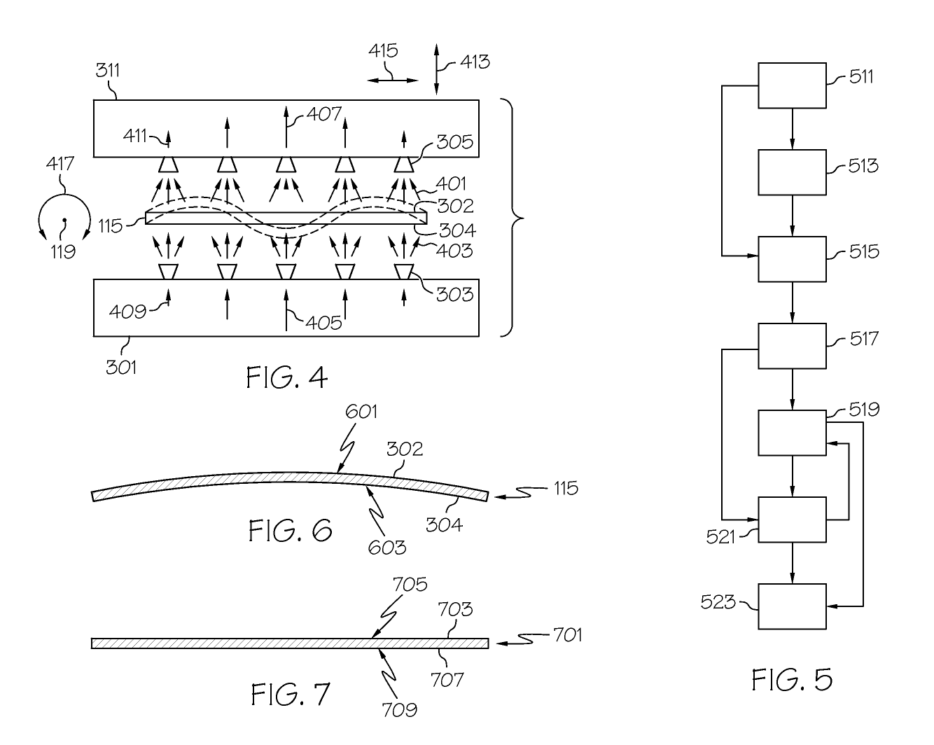

In one example, every nozzle 303, 305 can act as a fluid emitting nozzle. In further examples, every nozzle 303, 305 can act as a fluid vacuum nozzle. In another example, the plurality of nozzles of one of the pressure members can all act as a fluid vacuum nozzle while the plurality of nozzles of the other pressure member can all acts as a fluid emitting nozzle. For instance, as shown in FIG. 4, every fluid nozzle 303 of the first pressure member 301 is shown acting as fluid emitting nozzle while every fluid nozzle 305 of the second pressure member 311 is shown acting as a fluid vacuum nozzle. In addition or alternatively, the computer controller 323 may transmit commands along a transmission line 329 to control the fluid control manifold 319. The fluid control manifold can be designed to selectively place each of the fluid nozzles 303, 305 in communication with one or both of the pressure sources 315, 317.

Placement of the first pressure member 301 and the second pressure member 311 can be achieved by corresponding actuators 331, 333. Indeed, the computer controller 323 can operate the actuator 331 to appropriately position the first pressure member 301 with respect to the first side 302 of the glass ribbon 115. Likewise, the computer controller 323 can operate the actuator 333 to position the second pressure member 311 with respect to the second side 304 of the glass ribbon 115. As described below, proximity sensors 335, 337 can provide feedback to the computer controller 323 to facilitate automatic positioning of the first and second pressure members with respect to the glass ribbon 115.

FIG. 5 illustrates a flow chart representing methods of producing glass sheets 125. As shown, the method can begin with step 511 of fusion drawing a glass ribbon along a draw direction into a viscous zone downstream from a root of a forming wedge. For example, as shown in FIG. 1, the fusion draw machine 103 receives molten glass through the inlet 105. The molten glass is then received in a trough 107 of the forming vessel 109. The molten glass eventually spills over the trough 107 and flows down in the draw direction 119 along opposite sides of the forming wedge 111. The molten glass continues to flow down the opposite sides of the forming wedge 111 until they encounter the root 113 of the forming wedge 111. The molten glass is then fusion drawn as the glass ribbon 115 along the draw direction 119 into a viscous zone 129 downstream from the root 113 of the forming wedge 111.

As shown in FIG. 5, the method can include the optional step 513 of providing the glass ribbon 115 with a substantially curved cross-sectional profile in a direction of the width. The curved cross-sectional profile can be achieved with a wide variety of techniques. For instance, as shown the root 113 of the forming wedge 111 can be curved or otherwise configured to induce the curved cross-sectional profile in the viscous zone. In further examples, the curved cross-sectional profile may be achieved by way of techniques disclosed in U.S. Pat. Pub. No. 2008/0131651 that is herein incorporated by reference in its entirety.

Referencing back to FIG. 5, the method can further include the step 515 of drawing the glass ribbon into a setting zone downstream from the viscous zone. Indeed, as shown in FIG. 1, the glass ribbon 115 may travel along draw direction 119 into a setting zone 131 downstream from the viscous zone 129. In the setting zone 131, the glass ribbon is set from a viscous state to an elastic state with the desired cross-sectional profile. Once the glass ribbon is set in the elastic state, the profile of the glass ribbon in from the viscous zone 129 is frozen as a characteristic of the ribbon. While the set ribbon may be flexed away from this configuration, internal stresses will cause the glass ribbon to bias back to the original set profile and, in extreme cases, may cause the ribbon to overextend into a different orientation.

FIG. 6 is an example cross-sectional view of the glass ribbon 115 in the direction of the width of the glass ribbon 115 along lines 6A-6A, 6B-6B and 6C-6C of FIG. 1. As shown in FIG. 6, the example profile includes a substantially curved cross-sectional profile that provides the first side 302 of the glass ribbon 115 with a convex surface 601 and the second side of the glass ribbon with a concave surface 603. As shown along line 6A-6A of FIG. 1, the substantially curved cross-sectional profile induced in the viscous zone 129 can be set within the setting zone 131. As further shown, the same substantially curved cross-sectional profile can be carried through to an elastic zone 133 as shown by line 6B-6B and line 6C-6C of FIG. 1. In fact, as shown, throughout the elastic zone, the glass ribbon 115 may have substantially the same cross-sectional profile in a direction of the width of the glass ribbon 115. In further examples, the glass ribbon 115 may be curved to different degrees or may even have different curvatures throughout the elastic zone.

In still further examples, the glass ribbon 115 may be formed with a substantially straight cross-sectional profile. In such an example, step 513 of FIG. 5 may be eliminated. Thus, the method can proceed from step 511 of fusion drawing a glass ribbon directly to step 515 of drawing the glass ribbon into a setting zone downstream from the viscous zone. In such an example, the root 113 of the forming wedge 111 may be substantially straight or otherwise configured to form a substantially flat ribbon in the viscous zone 129. FIG. 7 illustrates and example of a glass ribbon 701 formed a substantially straight cross-sectional profile. Indeed, the glass ribbon 701 is illustrated with a first side 703 having a substantially flat surface 705 and a second side 707 having a similarly flat surface 709. FIG. 7 can be considered taken along lines 6A-6A, 6B-6B and 6C-6C of FIG. 1 when the fusion draw machine 103 is designed to produce a substantially flat ribbon. As represented by the profile shown in FIG. 7 that can exist along line 6A-6A of FIG. 1, the substantially straight cross-sectional profile can be provided in the viscous zone 129 and set within the setting zone 131. Moreover, as the profile can further exist at line 6B-6B and line 6C-6C of FIG. 1, the substantially straight cross-sectional profile can also exist through the elastic zone 133. Moreover, throughout the elastic zone, the glass ribbon 115 may have substantially the same straight cross-sectional profile in the direction of the width of the glass ribbon 115.

In still further examples, the glass ribbon 115 may have different cross-sectional profiles. For example, the glass ribbon may be formed with the first side 302 including a concave surface and the second side 304 including a convex surface. As shown, the cross-sectional profile may comprise a single curve although further profiles may have a sinusoidal curve or other curvilinear shape. Still further, the cross-sectional profile may change as it travels in the draw direction 119. For example, one or more different profiles may exist in the viscous zone 129, the setting zone 131 and or the elastic zone 133. For example, one or more straight, single curve, sinusoidal curve or other shape may exist at various locations along the draw direction 119 of the glass ribbon 115.

As further illustrated in FIG. 5, after setting the glass ribbon 115 during step 515, the glass ribbon 115 is drawn into an elastic zone downstream from the setting zone as indicated by step 517. Indeed, as shown in FIG. 1, the glass ribbon continues to be drawn downward in the draw direction 119 from the setting zone 131 to the elastic zone 133. The illustrated pull roll assembly 117 can facilitate drawing of the glass ribbon 115 from the root 113 in the draw direction 119. As such, the draw rate, thickness and other characteristics of the glass ribbon 115 can be controlled.

After reaching the setting zone, a region of the glass ribbon 115 can be stabilized by the stabilization device 123 during step 519 of FIG. 5. For example, as shown in FIGS. 3 and 4, the method includes stabilizing a region of the glass ribbon 115 in the elastic zone 113 along the width of the glass ribbon extending transverse with respect to the draw direction 119. As shown, the stabilization device 123 is separate from the cutting device 121 although the stabilization device 123 and the cutting device 121 may be provided as a single device in further examples. Moreover, as shown, the stabilization device 123 is located immediately upstream of the cutting device 121 although the stabilization device 123 may be provided in one or more other locations in further examples. For instance, the stabilization device 123 may be located further upstream within the elastic zone 133. Still further, a plurality of stabilization devices 123 may be provided at various locations along the elastic zone 133. For instance, two or more stabilization devices 123 may be provided at spaced locations along the elastic zone 133.

Referencing FIG. 3, the first pressure member 301 may be provided with one or more proximity sensors 335 and the second pressure member 311 may include one or more proximity sensors 337. The proximity sensors 311, 335 may provide positional information of the first pressure member 301 and the second pressure member 311 with respect to the glass ribbon 115. In response, the computer controller 323 can send a signal to the actuator 331 to move the first pressure member 301 to an appropriate position to apply fluid pressure to the second side 304 of the glass ribbon 115. Likewise, the computer controller 323 can sent another signal to actuator 333 to move the second pressure member 311 to a desirable position to apply fluid pressure to the first side 302 of the glass ribbon 115.

Although not shown, an array of proximity sensors may be provided along the width of the corresponding pressure member 301, 311. As such, each of the fluid nozzles 303, 305 may be appropriately positioned with respect to the glass ribbon 115. Proximity sensor feedback can allow the computer controller 323 to appropriately position the first pressure member 301 and the second pressure member 311 by way of the corresponding actuators 331, 333. For example, as shown in FIG. 4, one or both of the pressure members 301, 311 may be moved in translation directions 413, 415. As further shown in FIG. 8, one or both pressure members 301, 311 can also be moved in translation direction 811. Allowing the entire pressure member 301, 311 to move in one or more of the translation directions 413, 415, 811 can allow all of the nozzles to move simultaneously with the respective pressure member. In addition or alternatively, the nozzles 303, 305 may be configured to individually or collectively move with respect to the respective pressure member 301, 311 in one or more of the translation directions 413, 415, 811. Allowing individual movement of each of the nozzles can allow better control of the pressure differential at different locations along the width of the glass ribbon 115.

The proximity sensor feedback can also result in the controller causing rotational movement of the first pressure member 301 and/or the second pressure member 311 with respect to the glass ribbon 115 about any of the three coordinate axes. For example, as shown in FIG. 4, one or both of the pressure members 301, 311 may be moved in rotation direction 417 about an axis substantially parallel to the draw direction 119. As shown in FIG. 8, one or both of the pressure members 301, 311 may be moved in rotation direction 813 about an axis parallel to a direction of the width of the glass ribbon 115. Allowing the entire pressure member 301, 311 to rotate in one or more of the rotation directions can allow all of the nozzles to rotate simultaneously with the respective pressure member. In addition or alternatively, the nozzles 303, 305 may be configured to individually or collectively rotate with respect to the respective pressure member 301, 311 in a rotation direction about any of the three coordinate axes. For example, as shown in FIG. 4, one or more of the nozzles 303, 305 may rotate relative to the respective pressure member 301, 311 in rotation direction 417 about an axis substantially parallel to the draw direction 119. In addition or alternatively, as shown in FIG. 8, one or more of the nozzles 303, 305 may rotate relative to the respective pressure member 301, 311 in rotation direction 813 about an axis parallel to a direction of the width of the glass ribbon 115. Allowing individual rotational movement of each of the nozzles can allow further control of the pressure differential at different locations along the width of the glass ribbon 115.

In the illustrated example, the computer controller 323 can send a signal to the fluid control manifold 319 to place the plurality of fluid nozzles 305 of the second pressure member 311 in fluid communication with the negative pressure source 317. As such, the fluid nozzles 305 act as vacuum nozzles, drawing a stream of fluid 401, such as air, into the respective fluid nozzles 305 to create a negative pressure along the stabilized region of the glass ribbon 115. The computer controller 323 can also send a signal to the fluid control manifold 319 to place the plurality of fluid nozzles 303 of the first pressure member 301 in fluid communication with the positive pressure source 315. Therefore, the fluid nozzles 303 of the first pressure member 301 can act as fluid emission nozzles, emitting a stream of fluid 403, such as air, against the glass ribbon 115 to create a positive pressure along the stabilized region.

The computer controller 323 can also send signals to the positive pressure source 315 and/or the negative pressure source 317 to provide the desired pressure characteristics. The negative pressure applied to the first side 302 of the glass ribbon 115 together with the positive pressure applied to the second side 304 of the glass ribbon 115 can act together to provide a predetermined pressure differential between a first side and a second side of the glass ribbon 115. As shown, it is also possible to provide a pressure differential that has a varying pressure profile in a direction of the width of the glass ribbon 115. For example, the manifold 319 can include pressure regulators to control the pressure within each of the fluid conduits 313, 321 to control the stream of fluid 401, 403 at each respective nozzle. As such, various combinations of profiles may be achieved throughout the stabilization process. As shown by illustration, the nozzles may provide a pressure gradient in the direction of the width wherein the central nozzles have the largest pressure magnitudes 405, 407, while the outer peripheral nozzles have the lowest pressure magnitudes 409, 411. The pressure gradients of each nozzle set can both act together in the stabilization zone to provide the desired varying pressure profile in the direction of the width of the glass ribbon 115.

As further shown in FIG. 5, the method further includes the step 521 of cutting a glass sheet 125 from the glass ribbon 115. As shown in FIG. 5, the step 521 of cutting may occur before, after and/or during the step 519 of stabilizing. As shown in FIG. 2, the step of cutting can use a traveling anvil machine although other cutting techniques may be used in further examples. As still further shown in FIG. 5, the method can further include the step 523 of subdividing the glass sheet 125 into individual display glass sheets 127 for incorporating in the various display devices, such as a liquid crystal display (LCD).

One example method of stabilizing and cutting is illustrated in FIGS. 8-10. As shown in FIG. 8, the stream of fluid 403 is emitted from nozzles 303 of the first pressure member 301 and the stream of fluid 401 is drawn into the nozzles 305 of the second pressure member 311. As such, the pressure differential stabilizes the region of the glass ribbon 115 in the elastic zone upstream of the cutting area. A suction member 801, such as an air bearing or suction cup, is then engaged with what will become the glass sheet 125. The anvil portion 201 is then moved in direction 803 and to engage the first side 302 of the glass ribbon 115. The scoring portion 203 is also moved in direction 805 such that the working end 205 of the scoring portion 203 engages the second side 304 of the glass ribbon 115. Next, the scoring portion 203 is moved relative to the glass ribbon 115 (as shown in FIG. 2) to score the second side 304. During the scoring procedure, any glass particles 807 may be blown away in direction 809 by the stream of fluid 403 being emitted by the nozzle 303.

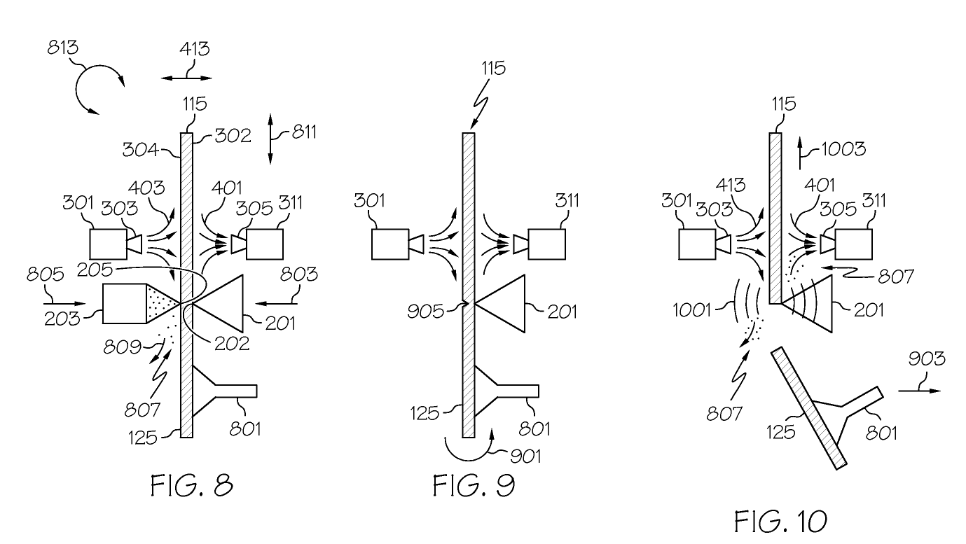

Once scored, as shown in FIG. 9, the suction member 801 can then rotate the glass sheet 125 along direction 901 about the score line 905 while the glass is supported behind the score line 905 by the anvil portion 201.

As shown in FIG. 10, the glass sheet 125 is then broken away from the remainder of the glass ribbon 115 along the score line 905 and moved inwardly along direction 903. As shown, any glass particles 807 produced during the step of breaking can be blown away by the stream of air 403 being emitted by the nozzle 303 of the first pressure member 301. Furthermore, glass particles entrained in the air stream 401 may be drawn into the fluid nozzles 305 of the second pressure member 311. Therefore, the second pressure member 311 can optionally act as a vacuum cleaner to remove glass particles from the vicinity of the cut edge of the glass ribbon 115. At the same time, the stabilized region created by the pressure differential can inhibit formation of shape instabilities 1001 and/or inhibit shape instabilities 1001 from propagating upstream along direction 1003 through the glass ribbon to the setting zone. Moreover, the pressure profile created by the nozzles can be adjusted to compensate for predetermined shape characteristics that may be encouraged due to the cutting process. For example, as shown in FIG. 4, the pressure differential may act against the tendency of the shape instabilities from inducing the shape profile illustrated in hidden lines. As such, the shape instabilities 1001 from traveling up the glass ribbon and interfering with the profile shape of the molten glass ribbon in the viscous zone 129; thereby allowing the desired shape to be maintained and set in the glass ribbon 115 within the setting zone 131.

It will be apparent to those skilled in the art that various modifications and variations can be made without departing from the spirit and scope of the claimed invention.

What is claimed is:

1. A method of producing glass sheets comprising the steps of:
fusion drawing a glass ribbon along a draw direction into a viscous zone downstream from a root of a forming wedge;
drawing the glass ribbon into a setting zone downstream from the viscous zone, wherein the glass ribbon is set from a viscous state to an elastic state;
drawing the glass ribbon into an elastic zone downstream from the setting zone;
stabilizing a region of the glass ribbon in the elastic zone along a width of the glass ribbon extending transverse with respect to the draw direction, wherein a predetermined pressure differential between a first side and a second side of the glass ribbon is used to create the stabilized region; and
cutting a glass sheet from the glass ribbon, wherein the stabilized region inhibits shape instabilities from propagating upstream through the glass ribbon to the setting zone.

2. The method of claim 1, further comprising the step of setting the glass ribbon with a substantially curved cross-sectional profile in a direction of the width.

3. The method of claim 2, wherein the substantially curved cross-sectional profile provides the first side of the glass ribbon with a convex surface in the elastic zone and the second side of the glass ribbon with a concave surface in the elastic zone.

4. The method of claim 1, further comprising the step of setting the glass ribbon with a substantially straight cross-sectional profile in a direction of the width.

5. The method of claim 1, wherein, throughout the elastic zone, the glass ribbon has substantially the same cross-sectional profile in a direction of the width.

6. The method of claim 1, wherein the stabilized region inhibits formation of shape instabilities resulting from the step of cutting the glass ribbon.

7. The method of claim 1, wherein the pressure differential is provided with a varying pressure profile in a direction of the width.

8. The method of claim 1, wherein the at least one fluid vacuum nozzle is used to create the pressure differential.

9. The method of claim 8, wherein the at least one fluid vacuum nozzle is further used to collect glass chips during the step of cutting the glass ribbon.

10. The method of claim 8, wherein the at least one fluid vacuum nozzle is used to provide the pressure differential with a varying pressure profile in a direction of the width.

11. The method of claim 8, wherein at least one fluid emitting nozzle is used with the at least one fluid vacuum nozzle to create the pressure differential.

12. The method of claim 11, wherein the at least one fluid emitting nozzle is used with the at least one fluid vacuum nozzle to provide the pressure differential with a varying pressure profile in a direction of the width.

13. The method of claim 11, wherein the at least one fluid emitting nozzle is used to remove glass chips from the glass ribbon during the step of cutting the glass ribbon.

14. The method of claim 1, wherein at least one fluid emitting nozzle is used to emit fluid against the stabilized region of the glass ribbon to create the pressure differential.

15. The method of claim 14, wherein the at least one fluid emitting nozzle is used to provide the pressure differential with a varying pressure profile in a direction of the width.

16. The method of claim 14, wherein the at least one fluid emitting nozzle is used to remove glass chips from the glass ribbon during the step of cutting the glass ribbon.

17. The method of claim 1, wherein the step of cutting uses a traveling anvil machine.
